(19) United States
(12) Patent Application Publication
(10) Pub. No.: US 2024/0372129 A1
(43) Pub. Date: Nov. 7, 2024

(54) BATTERY AND ELECTRONIC APPARATUS INCLUDING SAME

(71) Applicant: Ningde Amperex Technology Limited, Ningde (CN)

(72) Inventor: Huimin GAO, Ningde (CN)

(73) Assignee: Ningde Amperex Technology Limited, Ningde (CN)

(21) Appl. No.: 18/778,048

(22) Filed: Jul. 19, 2024

Related U.S. Application Data
(63) Continuation of application No. PCT/CN2022/072827, filed on Jan. 19, 2022.

(51) Int. Cl. H01M 10/04; H01M 4/66; H01M 50/105; H01M 50/533

(52) U.S. Cl. CPC H01M 10/0431; H01M 4/661; H01M 50/105; H01M 50/533

(57) ABSTRACT

An electrode assembly includes a first conductive layer, a second conductive layer, and a first layer disposed between the first conductive layer and the second conductive layer, where the first layer contains an insulating material. The first conductive plate is connected to the first conductive layer and extends in a first direction from the first conductive layer. The housing encapsulates the electrode assembly and covers at least a part of the first conductive plate. The housing includes a first side surface opposite the electrode assembly in the first direction. The first conductive layer includes a plurality of sides opposite the first side surface in the first direction; the plurality of sides include a first side group formed by more than two first sides arranged consecutively and a second side group formed by more than two second sides arranged consecutively in a second direction.

### CROSS-REFERENCE TO RELATED APPLICATION

This application is a continuation of International Patent Application No. PCT/CN2022/072827, filed on Jan. 19, 2022, the disclosure of which is hereby incorporated by reference in its entirety.

### TECHNICAL FIELD

This application relates to the field of energy storage apparatuses, and in particular, to a battery and an electronic apparatus including such battery.

### BACKGROUND

Lithium-ion batteries have many advantages such as high energy density, long cycle life, high nominal voltage, low self-discharge rate, small size, and light weight, and therefore are widely used in the field of consumer electronics. With the rapid development of electric vehicles and mobile electronic devices in recent years, people have increasingly high relevant requirements on the energy density, service life, cycling performance, and the like of batteries. Therefore, it is necessary to continuously optimize structures of batteries.

### SUMMARY

An objective of this application is to propose a battery which can have a longer service life.

According to a first aspect, this application provides a battery including an electrode assembly, a first conductive plate, and a housing. The electrode assembly includes a first conductive layer, a second conductive layer, and a first layer disposed between the first conductive layer and the second conductive layer, where the first layer contains an insulating material. The first conductive plate is connected to the first conductive layer and extends in a first direction from the first conductive layer. The housing encapsulates the electrode assembly and covers at least a part of the first conductive plate. The housing includes a first side surface opposite the electrode assembly in the first direction. The first conductive layer includes a plurality of sides opposite the first side surface in the first direction, where the plurality of sides include a first side group formed by more than two first sides arranged consecutively and a second side group formed by more than two second sides arranged consecutively in a second direction, and the second direction is perpendicular to the first direction. In the first direction, distances from the first sides in the first side group to the first side surface are all greater than distances from the second sides in the second side group to the first side surface.

In the battery provided in this application, the electrode assembly is provided with the first side group and the second side group on a side connected to the conductive plate, forming a stair-stepping edge structure. In addition, a stable cavity structure is formed between the electrode assembly and the housing by the first side group, the second side group, and side surfaces of the housing. The cavity structure can be used for storing an electrolyte and gas so as to prolong the service life of the battery. Moreover, due to the presence of the cavity structure, a sufficient distance is present between the electrode assembly and the housing, thereby reducing the risk of powder falling and housing damage caused by extrusion of corners of the electrode assembly during dropping of the battery, and prolonging the service life.

According to some embodiments of this application, the electrode assembly includes a bent portion extending in the first direction and protruding in the second direction.

According to some embodiments of this application, the electrode assembly includes a portion protruding from the second side group to the first side group in the second direction.

According to some embodiments of this application, observed in the second direction, the first side group and the first side surface are arranged in a manner as follows: a first straight line connecting adjacent two of the first sides in the first side group is intersected with a second straight line coincident with the first side surface.

According to some embodiments of this application, the electrode assembly is formed by stacking or winding the first conductive layer, the first layer, and the second conductive layer, and a direction of a winding shaft of the electrode assembly is the first direction.

According to some embodiments of this application, observed in the second direction, the first conductive layer includes a first region having a distance to the first side surface in the first direction greater than a distance from the first side to the first side surface, and a first protrusion portion having a distance to the first side surface less than the distance from the first side to the first side surface.

According to some embodiments of this application, the first protrusion portion is bent between the first region and the first side surface.

According to some embodiments of this application, a first cavity is formed between the first side group and the housing, and the first protrusion portion is bent in the first cavity.

According to some embodiments of this application, the first conductive layer is a positive electrode.

According to some embodiments of this application, the first conductive layer includes a first conductor layer, and the first conductor layer includes aluminum.

According to some embodiments of this application, the second conductive layer is a negative electrode.

According to some embodiments of the application, the second conductive layer includes a second conductor layer, and the second conductor layer includes copper.

According to some embodiments of this application, a second cavity is formed between the second side group and the housing.

According to some embodiments of the application, the electrode assembly has a length L in the first direction, the first layer located in the first side group has a length L₁ in the first direction, and a second layer located in the second side group has a length L₂ in the first direction, where L₁<L₂<L.

According to a second aspect, this application further provides an electronic apparatus including the foregoing battery.

### BRIEF DESCRIPTION OF DRAWINGS

The above and/or additional aspects and advantages of this application will become obviously easy to understand from the description of some embodiments with reference to the following drawings.

FIG. 1 is a schematic diagram of a battery according to an embodiment of this application;

FIG. 2 is a schematic cross-sectional view of the battery shown in FIG. 1 along line II-II;

FIG. 3 is a schematic cross-sectional view of the battery shown in FIG. 1 along line III-III;

FIG. 4 is a schematic cross-sectional view of the battery shown in FIG. 1 along line IV-IV;

FIG. 5 is a schematic cross-sectional view of a battery according to another embodiment of this application, where a cross section position in the schematic cross-sectional view is the same as that of line II-II in FIG. 2;

FIG. 6A is a schematic cross-sectional view of a battery according to still another embodiment of this application, where a cross section position in the schematic cross-sectional view is the same as that of line II-II in FIG. 2;

FIG. 6B is a schematic cross-sectional view of a battery according to yet another embodiment of this application, where a cross section position in the schematic cross-sectional view is the same as that of line II-II in FIG. 2;

FIG. 7 is a schematic cross-sectional view of a battery according to yet another embodiment of this application, where a cross section position in the schematic cross-sectional view is the same as that of line II-II in FIG. 2;

FIG. 8 is a schematic diagram of a battery according to another embodiment of this application;

FIG. 9 is a schematic cross-sectional view of the battery shown in FIG. 8 along line IX-IX;

FIG. 10 is a schematic cross-sectional view of a battery according to still another embodiment of this application, where a cross section position in the schematic cross-sectional view is the same as that of line II-II in FIG. 2; and

FIG. 11 is a schematic diagram of an electronic apparatus according to an embodiment this application.

### REFERENCE SIGNS OF MAIN COMPONENTS

battery 100
electrode assembly 10
first conductive plate 20
second conductive plate 30
housing 40
first side surface 41
second side surface 42
third side surface 43
fourth side surface 44
first conductive layer 11
1st first conductive layer 113
2nd first conductive layer 116
3rd first conductive layer 117
4th first conductive layer 118
5th first conductive layer 119
second conductive layer 12
first layer 13
first conductor layer 111
first conductive material layer 112
second conductor layer 121
second conductive material layer 122
first side 11a
1st first side 11a1
2nd first side 11a2
second side 11b
1st second side 11b1
2nd second side 11b2
3rd third side 11b3
fourth side 11c, 11c1, 11c2, 11c3
first region 114
1st first region 114a
2nd first region 114b
3rd first region 114c
4th first region 114d
5th first region 114e
first protrusion portion 115
1st first protrusion portion 115a
2nd first protrusion portion 115b
3rd first protrusion portion 115c
4th first protrusion portion 115d
5th first protrusion portion 115e
sixth side 12a
seventh side 12b, 12b1, 12b2, 12b3
fifth side 12c, 12c1, 12c2, 12c3
second region 124
second protrusion portion 125
eighth side 13c, 13c1, 13c2, 13c3
ninth side 13a, 13a1, 13a2
tenth side 13b, 13b1, 13b2, 13b3
first side group 11A
second side group 11B
first cavity 401
second cavity 402
eleventh side 11d, 11d1, 11d2, 11d3
twelfth side 11e, 11e, 11e1, 11e2
thirteenth side 12d, 12d1, 11d2, 11d3
fourteenth side 12e, 12e1, 12e2, 12e3
fifteenth side 13d, 13d1, 13d2, 13d3
sixteenth side 13e, 13e1, 13e2, 13e3
bent portion 101
third side 11f
seventeenth side 12f
eighteenth side 13f
third side group 11C, 11C′
electronic apparatus 200
body 220
body portion 410
sealing portion 420
first surface 45
second surface 46
fourth side group 11D
fifth side group 11E
sixth side group 11F
first sealing portion 420a
second sealing portion 420b
third sealing portion 420c
accommodating cavity; 411
bent surface 47
first portion 41a
second portion 41b

### DETAILED DESCRIPTION

The following clearly describes in detail the technical solutions in some embodiments of this application. Apparently, the described embodiments are merely some rather than all of the embodiments of this application. Unless otherwise defined, all technical and scientific terms used herein shall have the same meanings as commonly understood by persons skilled in the art to which this application belongs. The terms used in the specification of this application are merely intended to describe specific embodiments rather than to constitute any limitation on this application.

The following describes some embodiments of this application in detail. However, this application may be embodied in many different implementations and should not be construed as being limited to the example embodiments illustrated herein. Rather, these example embodiments are provided so that this application can be conveyed to those skilled in the art thoroughly and in detail.

In addition, in the accompanying drawings, sizes or thicknesses of various components and layers may be exaggerated for brevity and clarity. Throughout the text, the same numerical values represent the same elements. As used herein, the term “and/or” includes any and all combinations of one or more of the associated listed items. In addition, it should be understood that when an element A is referred to as being “connected to” an element B, the element A can be directly connected to the element B or an intervening element C may be present therebetween such that the element A and the element B can be indirectly connected to each other.

Further, the use of “may” when describing embodiments of this application relates to “one or more embodiments of this application.”

The terminology used herein is merely intended to describe specific embodiments rather than to limit this application. As used herein, the singular forms are intended to include the plural forms as well, unless otherwise clearly indicated in the context. It should be further understood that the term “comprise” or “include”, when used in this specification, specifies the presence of stated features, numbers, steps, operations, elements, and/or components but do not preclude the presence or addition of one or more other features, numbers, steps, operations, elements, components, and/or combinations thereof.

Spatial related terms such as “above” may be used herein for ease of description to describe the relationship between one element or feature and another element (multiple elements) or feature (multiple features) as illustrated in the figure. It should be understood that spatial related terms are intended to include different orientations of a device or an apparatus in use or operation in addition to the orientations depicted in the figures. For example, if the device in the figures is turned over, elements described as “above” or “over” other elements or features would then be oriented “below” or “beneath” the other elements or features. Thus, the example term “above” can include both orientations of above and below. It should be understood that although the terms first, second, third, or the like may be used herein to describe various elements, components, regions, layers, and/or portions, these elements, components, regions, layers, and/or portions should not be limited by these terms. These terms are used to distinguish one element, component, region, layer, or portion from another element, component, region, layer, or portion. Therefore, the first element, component, region, layer, or portion discussed below may be referred to as the second element, component, region, layer, or portion without departing from the teachings of the example embodiments.

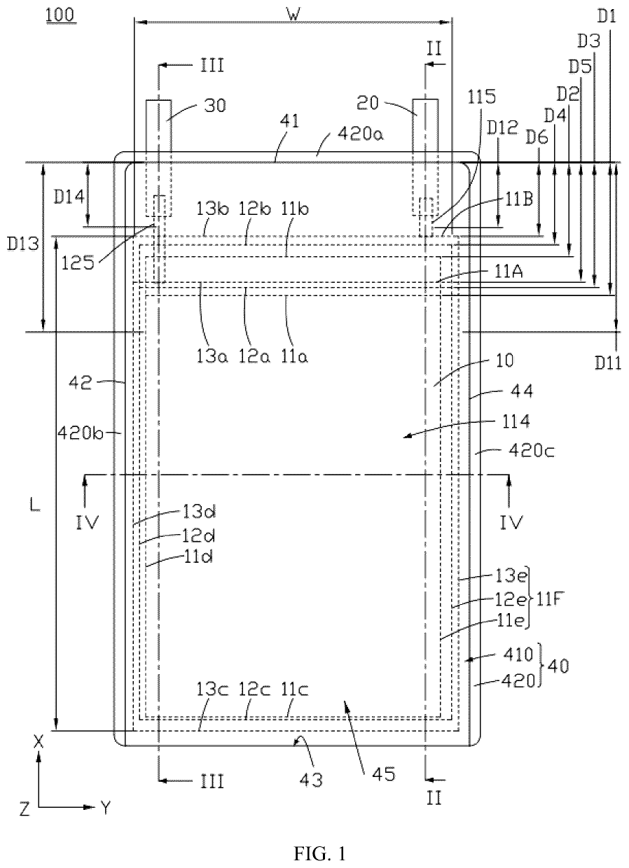

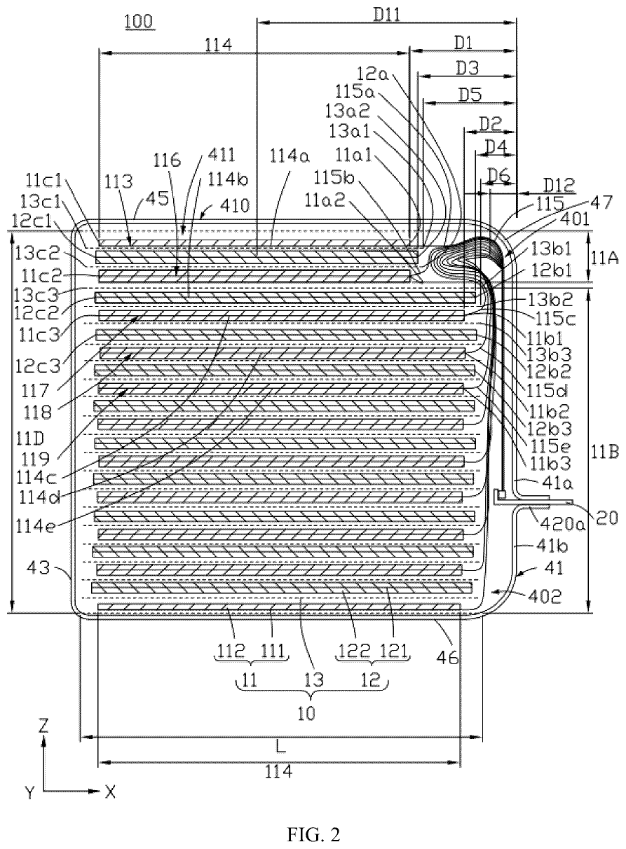

Referring to FIG. 1 and FIG. 2, an embodiment of this application provides a battery 100 including an electrode assembly 10, a first conductive plate 20, a second conductive plate 30, and a housing 40. The first conductive plate 20 and the second conductive plate 30 are both connected to the electrode assembly 10. The housing 40 encapsulates the electrode assembly 10 and covers at least a part of the first conductive plate 20 and at least a part of the second conductive plate 30. In this embodiment, the first conductive plate 20 and the second conductive plate 30 are located on a same side of the battery 100 and extend out of the housing 40. The first conductive plate 20 may be a positive electrode, which may include at least one of Ni, Ti, Al, Ag, Au, Pt, Fe, or a composition thereof. The second conductive plate 30 may be a negative electrode, which may include at least one of Ni, Ti, Cu, Ag, Au, Pt, Fe, or a composition thereof.

The housing 40 may include a body portion 410 and a sealing portion 420. The body portion 410 is provided with an accommodating cavity 411 for accommodating an electrolyte, the electrode assembly 10, at least a part of the first conductive plate 20, and at least a part of the second conductive plate 30. The body portion 410 includes a first surface 45, a second surface 46, a first side surface 41, a second side surface 42, a third side surface 43, and a fourth side surface 44. The first side surface 41, the second side surface 42, the third side surface 43, and the fourth side surface 44 are sequentially connected and enclosed to form the accommodating cavity 411. The first surface 45 and the second surface 46 respectively seals two openings of the accommodating cavity 411 so as to seal the accommodating cavity. The first surface 45 can be connected to the first side surface 41, the second side surface 42, the third side surface 43, and the fourth side surface 44 through a bent surface 47 so as to seal an opening of the accommodating cavity 411. In this application, a direction in which the first surface 45 and the second surface 46 are arranged is defined as a second direction Z, a direction in which the first conductive plate 20 and the second conductive plate 30 are arranged is defined as a third direction Y, and a first direction X is perpendicular to the second direction Z and the third direction Y. In the second direction Z, the first surface 45 and the second surface 46 are disposed opposite each other, the first surface 45 can extend in the first direction X and the third direction Y, and the second surface 46 can extend in the first direction X and the third direction Y. In the first direction X, the first side surface 41 and the third side surface 43 are disposed opposite each other; the first side surface 41 can extend in the second direction Z and the third direction Y, and the third side surface 43 can extend in the second direction Z and the third direction Y. In the third direction Y, the second side surface 42 and the fourth side surface 44 are disposed opposite each other, the second side surface 42 can extend in the second direction Z and the first direction X, and the fourth side surface 44 can extend in the second direction Z and the first direction X. A sealing portion 420 extends from a surface of a body portion 410 to a side away from the body portion 410. The sealing portion 420 is a portion sealed using a hot-pressing process, an adhesion process, or the like after the electrode assembly 10 and the electrolyte are accommodated in the housing 40. In this embodiment, the sealing portion 420 includes a first sealing portion 420a, a second sealing portion 420b, and a third sealing portion 420c connected sequentially. The first sealing portion 420a extends from the first side surface 41 to a side away from the body portion 410, the second sealing portion 420b extends from the second side surface 42 to a side away from the body portion 410, and the third sealing portion 420c extends from the fourth side surface 44 to a side away from the body portion 410. The first conductive plate 20 and the second conductive plate 30 extend out of the housing 40 from the first sealing portion 420a located on the first side surface 41. In the second direction Z, the first side surface 41 further includes a first portion 41a located on a side of the first conductive plate 20 close to the first surface 45, and a second portion 41b located on a side of the first conductive plate 20 close to the second surface 46.

In some embodiments, at least a part of the surfaces and side surfaces of the body portion 410 may have a conductive material to enhance mechanical strength of the housing 40. The housing 40 may be a metal housing, for example, a steel housing or an aluminum housing. In some other embodiments, the housing 40 may alternatively be a packaging bag obtained by packaging with a packaging film, meaning that the battery 100 is a soft pack battery.

The electrode assembly 10 includes a first conductive layer 11, a second conductive layer 12, and a first layer 13 disposed between the first conductive layer 11 and the second conductive layer 12. The electrode assembly 10 is formed by stacking or winding the first conductive layer 11, the first layer 13, and the second conductive layer 12. When the electrode assembly 10 is formed by winding the first conductive layer 11, the first layer 13, and the second conductive layer 12, a direction of a winding shaft of the electrode assembly 10 is the first direction X. In FIG. 2, the electrode assembly 10 is formed by sequentially and alternately stacking a plurality of first conductive layers 11, a plurality of first layers 13, and a plurality of second conductive layers 12 in the second direction Z. In some embodiments, one of the first conductive layer 11 or the second conductive layer 12 is a positive electrode, and the other one is a negative electrode. In some embodiments, the first conductive layer 11 is a positive electrode, the second conductive layer 12 is a negative electrode, and in the first direction X, an edge of the second conductive layer 12 protrudes out of an edge of the first conductive layer 11. In some other embodiments, the first conductive layer 11 is a negative electrode, the second conductive layer 12 is a positive electrode, and in the first direction X, the edge of the first conductive layer 11 protrudes out of the edge of the second conductive layer 12. It should be noted that in a schematic cross-sectional view, a cross section of the first conductive layer 11 is represented by a left oblique line, a cross section of the second conductive layer 12 is represented by a right oblique line, and a cross section of the first layer 13 is represented by a dotted line segment.

The first conductive layer 11 includes a first conductor layer 111 and a first conductive material layer 112 provided on the first conductor layer 111. The first conductor layer 111 includes a region provided with the first conductive material layer 112 and a region away from the first conductive material layer 112. The first conductor layer 111 may have functions of a current collector, and may include at least one of Ni, Ti, Ag, Au, Pt, Fe, Al, or a composition thereof. In these embodiments, the first conductor layer contains aluminum. The first conductive material layer 112 may have functions of an active layer, and may include at least one of lithium cobaltate, lithium manganate, lithium nickelate, lithium nickel cobalt manganate, lithium iron phosphate, lithium manganese iron phosphate, lithium vanadium phosphate, lithium vanadyl phosphate, a lithium-rich manganese-based material, lithium nickel cobalt aluminate, or a composition thereof.

The second conductive layer 12 includes a second conductor layer 121 and a second conductive material layer 122 provided on the second conductor layer 121. The second conductor layer 121 includes a region provided with the second conductive material layer 122 and a region away from the second conductive material layer 122. The second conductor layer 121 may have functions of a current collector, and may include at least one of Ni, Ti, Cu, Ag, Au, Pt, Fe, or a composition thereof. In these embodiments, the second conductive layer 12 contains copper. The second conductive material layer 122 has functions of an active layer and may be selected from at least one of a graphite material, an alloy material, lithium metal, or alloy thereof. The graphite material is selected from at least one of artificial graphite or natural graphite, and the alloy material is selected from at least one of silicon, silicon oxide, tin, or titanium sulfide.

The first layer 13 is configured to prevent direct contact between the first conductive layer 11 and the second conductive layer 12, thereby reducing the risk of a short circuit caused by contact between the first conductive layer 11 and the second conductive layer 12. The first layer 13 contains an insulating material. The insulating material is selected from at least one of polypropylene, polyethylene, polyvinylidene fluoride, a vinylidene fluoride-hexafluoropropylene copolymer, polymethyl methacrylate, or polyethylene glycol. The first layer 13 may be a separator.

The first conductive layer 11 further includes a plurality of sides opposite the first side surface 41 in the first direction X and a plurality of fourth sides 11c opposite the third side surface 43. FIG. 2 shows three fourth sides 11c1, 11c2, and 11c3 arranged consecutively in the second direction Z, and the remaining fourth sides 11c are not marked. The plurality of sides of the first conductive layer 11 opposite the first side surface 41 in the first direction X include more than two first sides 11a arranged consecutively and more than two second sides 11b arranged consecutively in the second direction Z. FIG. 2 shows a 1st first side 11a1 and a 2nd first side 11a2 arranged consecutively as well as a 1st second side 11b1, a 2nd second side 11b2 and a 3rd third side 11b3 arranged consecutively in the second direction Z, and the remaining second sides 11b are not marked. In the second direction Z, the more than two first sides 11a arranged consecutively are flush with each other, the more than two second sides 11b arranged consecutively are flush with each other, and the plurality of fourth sides 11c are flush with each other. In this application, the plurality of sides (for example, the plurality of first sides 11a, the plurality of second sides 11b, the plurality of fourth sides 11c, and the like) being flush with each other in the second direction Z mean that relatively protruding distances of the plurality of sides in the first direction X or the third direction Y are within 0 mm to 1 mm. To be specific, the relatively protruding distances, in the first direction X, of the 1st first side 11a1 and the 2nd first side 11a2 arranged consecutively are within 0 mm to 1 mm; the relatively protruding distances, in the first direction X, of the 1st second side 11b1, the 2nd second side 11b2, and the 3rd second side 11b3 arranged consecutively are within 0 mm to 1 mm; and the relatively protruding distances, in the first direction X, of the three fourth sides 11c1, 11c2, and 11c3 are within 0 mm to 1 mm. In the first direction X, a minimum distance D1 from the first sides 11a to the first side surface 41 is greater than a maximum distance D2 from the second sides 11b to the first side surface 41, such that distances from the first sides 11a to the first side surface 41 are all greater than distances from the second sides 11b to the first side surface 41. In this application, the distances from the sides to the first side surface 41 are distances from the first sides 11a to an extension surface of the first side surface 41 in the second direction Z. In some embodiments, relatively protruding distances of the first sides 11a in the first direction X are 0, meaning that the distances from the first sides 11a to the first side surface 41 are equal and are all D1; and relatively protruding distances of the second sides 11b in the first direction X are 0, meaning that the distances from the second sides 11b and the first side surface 41 are equal and are all D2.

In the second direction Z, the more than two first sides 11a arranged consecutively form a first side group 11A, and the more than two second sides 11b arranged consecutively form a second side group 11B. A minimum distance from the first sides 11a in the first side group 11A to the first side surface 41 is greater than a maximum distance from the second sides 11b in the second side group 11B to the first side surface 41, such that the distances from the first sides 11a in the first side group 11A to the first side surface 41 are all greater than the distances from the second sides 11b in the second side group 11B to the first side surface 41. In the first direction X, the first side 11a in the first side group 11A closest to the first side surface 41 serves as an edge of the first side group 11A, and the second side 11b in the second side group 11B farthest from the first side surface 41 serves as an edge of the second side group 11B.

A first cavity 401 is formed between the first side group 11A and the housing 40, and a second cavity 402 is formed between the second side group 11B and the housing 40. The first cavity 401 and the second cavity 402 may be configured to store a part of the electrolyte. After the electrolyte in the electrode assembly 10 is consumed, the electrolyte stored in the first cavity 401 and the second cavity 402 can provide supplement under a capillary or pressure difference effect, thereby prolonging the service life of the battery. The first cavity 401 and the second cavity 402 may further be configured to store gases produced during use of the battery, thereby alleviating appearance swelling of the battery and prolonging the service life. In addition, due to the presence of the first cavity 401 and the second cavity 402, the plurality of sides of the electrode assembly 10 have sufficient distances with the housing 40, reducing the risk of powder falling and housing damage caused by extrusion of corners of the electrode assembly 10 during dropping of the battery 100 and prolonging the service life.

The first conductive layer 11 further includes a first region 114 and a first protrusion portion 115. The first region 114 is provided with the first conductive material layer 112. The first protrusion portion 115 protrudes out of the first region 114, is accommodated in the housing 40, and is connected to the first conductive plate 20. In the second direction Z, a plurality of edges, opposite the first side surface 41 in the first direction X, of the first regions 114 of some first conductive layers 11 of the plurality of first conductive layers 11 are the plurality of first sides 11a arranged consecutively and form the first side group 11A; and a plurality of edges, opposite to the first side surface 41 in the first direction X, of the first regions 114 of the other first conductive layers 11 are the plurality of second sides 11b arranged consecutively and form the second side group 11B. FIG. 2 shows a 1st first conductive layer 113, a 2nd first conductive layer 116, a 3rd first conductive layer 117, a 4th first conductive layer 118, and a 5th first conductive layer 119 arranged consecutively in the second direction Z, and the remaining first conductive layers 11 are not marked. The 1st first conductive layer 113 includes a 1st first region 114a and a 1st first protrusion portion 115a protruding out of the 1st first region 114a. The 1st first side 11a1 is an edge of the 1st first region 114a facing the first side surface 41 in the first direction X, and the 1st first region 114a is separated from the 1st first protrusion portion 115a by the 1st first side 11a1. The 2nd first conductive layer 116 includes a 2nd first region 114b and a 2nd first protrusion portion 115b protruding out of the 2nd first region 114b. The 2nd first side 11a2 is an edge of the 2nd first region 114b facing the first side surface 41 in the first direction X and is also a boundary between the 2nd first region 114b and the 2nd first protrusion portion 115b. The 3rd first conductive layer 117 includes a 3rd first region 114c and a 3rd first protrusion portion 115c protruding out of the 3rd first region 114c. The 1st second side 11b1 is an edge of the 3rd first region 114c facing the first side surface 41 in the first direction X and is also a boundary between the 3rd first region 114c and the 3rd first protrusion portion 115c. The 4th first conductive layer 118 includes a 4th first region 114d and a 4th first protrusion portion 115d protruding out of the 4th first region 114d. The 2nd second side 11b2 is an edge of the 4th first region 114d facing the first side surface 41 in the first direction X and is also a boundary between the 4th first region 114d and the 4th first protrusion portion 115d. The 5th first conductive layer 119 includes a 5th first region 114e and a 5th first protrusion portion 115e. The 3rd second side 11b3 is an edge of the 5th first region 114e facing the first side surface 41 in the first direction X and is also a boundary between the 5th first region 114e and the 5th first protrusion portion 115e. In this way, the first regions 114 and the first protrusion portions 115 of the plurality of first conductive layers 11 are separated by the corresponding first sides 11a or second sides 11b. In the first direction X, the first region 114 is closer to the third side surface 43 than the first side 11a or the second side 11b, and the first protrusion portion 115 is closer to the first side surface 41 than the first side 11a or the second side 11b.

In some embodiments, the first protrusion portion 115 is bent between the first region 114 and the first side surface 41, thereby reducing space occupied by the first protrusion portion 115 in the first direction X and facilitating miniaturization of the electrode assembly 10.

In some embodiments, a bent portion, bent between the first region 114 and the first side surface 41, of the 1st first protrusion portion 115a is in contact with a bent surface 47 of the housing 40.

In some embodiments, the first protrusion portion 115 is bent in the first cavity 401, thereby further reducing space occupied by the battery 100 in the first direction X and facilitating miniaturization of the battery 100. The first conductive plate 20 is at least partially accommodated in the second cavity 402 and is connected to the bent first protrusion portion 115.

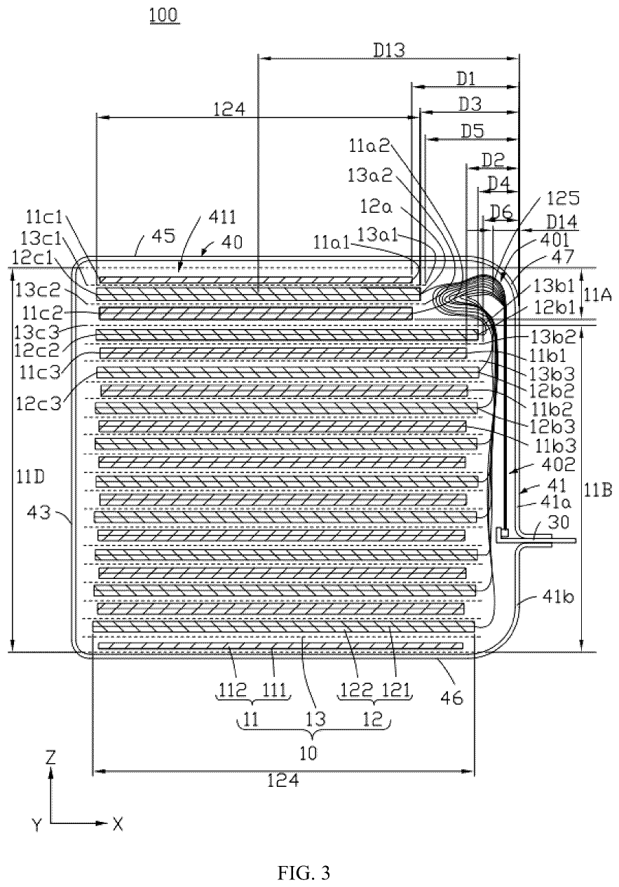

Referring to FIG. 2 and FIG. 3, the second conductive layer 12 further includes a plurality of sides opposite the first side surface 41 in the first direction X and a plurality of fifth sides 12c opposite the third side surface 43. For ease of understanding, FIG. 2 and FIG. 3 show three fifth sides 12c1, 12c2, and 12c3, and the remaining fifth sides 12c are not marked. The plurality of sides of the second conductive layer 12 opposite the first side surface 41 in the first direction X include more than two sixth sides 12a arranged consecutively in the second direction Z and more than two seventh sides 12b arranged consecutively in the second direction Z. FIG. 2 and FIG. 3 show one sixth side 12a, and this sixth side 12a is located between two first sides 11a1 and 11a2 arranged consecutively. In other embodiments, the second conductive layer 12 may include a plurality of sixth sides 12a arranged consecutively in the second direction Z, and the plurality of sixth sides 12a and the plurality of first sides 11a are alternatively arranged in the second direction Z. For ease of understanding, FIG. 2 and FIG. 3 show three seventh sides 12b1, 12b2, and 12b3 arranged consecutively in the second direction Z, and the remaining seventh sides 12b are not marked. In the second direction Z, the three seventh sides 12b1, 12b2, and 12b3 arranged consecutively and the three second sides 11b1, 11b2, and 11b3 arranged consecutively are alternatively arranged. In the second direction Z, the more than two sixth sides 12a arranged consecutively are flush with each other, the more than two seventh sides 12b arranged consecutively are flush with each other, and the plurality of fifth sides 12c are flush with each other. In the first direction X, a minimum distance D3 from the sixth sides 12a to the first side surface 41 is greater than a maximum distance D4 from the seventh sides 12b to the first side surface 41, such that all the sixth sides 12a are longer than the seventh sides 12b. In these embodiments, relatively protruding distances of the sixth sides 12a in the first direction X are 0, meaning that the distances from the sixth sides 12a to the first side surface 41 are equal and are all D3; and relatively protruding distances of the seventh sides 12b in the first direction X are 0, meaning that the distances from the seventh sides 12b to the first side surface 41 are equal and are all D4.

In the second direction Z, the more than two sixth sides 12a arranged consecutively can form a side group structure similar to the first side group 11A, and the more than two seventh sides 12b arranged consecutively can form a side group structure similar to the second side group 11B.

The second conductive layer 12 further includes a second region 124 and a second protrusion portion 125. The second region 124 is provided with the second conductive material layer 122. The second protrusion portion 125 protrudes out of the second region 124, is accommodated in the housing 40, and is connected to the second conductive plate 30. The second conductive layer 12 is similar to the first conductive layer 11 in structure. The second regions 124 and the second protrusion portions 125 of some second conductive layers 12, located in a region where the first side group 11A is located, of the plurality of second conductive layers 12 arranged in the second direction Z are separated by the sixth sides 12a. The second regions 124 and the second protrusion portions 125 of the second conductive layers 12 located in a region where the second side group 11B is located are separated by the seventh sides 12b. To be specific, the second regions 124 and the second protrusion portions 125 of the plurality of second conductive layers 12 are separated by the corresponding sixth sides 12a or seventh sides 12b. In the first direction X, the second region 124 is closer to the third side surface 41 than the sixth side 12a or the seventh side 12b, and the second protrusion portion 125 is closer to the first side surface than the sixth side 12a or the seventh side 12b. Observed in the second direction Z, in the first direction X, a distance D13 from the second region 124 to the first side surface 41 is greater than the distance D3 from the sixth side 12a to the first side surface 41, and a distance D14 from the second protrusion portion 125 to the first side surface 41 is less than the distance D3 from the sixth side 12a to the first side surface 41. Observed in the second direction Z, the second region 124 and the first region 114 overlap partially.

In some embodiments, the second protrusion portion 125 is bent between the second region 124 and the first side surface 41, thereby reducing space occupied by the second protrusion portion 125 in the first direction X and facilitating miniaturization of the electrode assembly 10.

In some embodiments, the second protrusion portion 125 is bent in the first cavity 401, thereby further reducing space occupied by the battery 100 in the first direction X and facilitating miniaturization of the battery 100. The second conductive plate 30 is at least partially accommodated in the second cavity 402 and is connected to the bent first protrusion portion 115.

The first layer 13 includes a plurality of sides opposite the first side surface 41 in the first direction X and a plurality of eighth sides 13c opposite the third side surface 43. FIG. 2 and FIG. 3 show three eighth sides 13c1, 13c2, and 13c3, and the remaining eighth sides 13c are not marked. The plurality of sides of the first layer 13 opposite the first side surface 41 in the first direction X include more than two ninth sides 13a arranged consecutively and more than two tenth sides 13b arranged consecutively in the second direction Z. For ease of understanding, FIG. 2 and FIG. 3 show two ninth sides 13a1, and 13a2 arranged consecutively and three tenth sides 13b1, 13b2, and 13b3 arranged consecutively in the second direction Z, and the remaining ninth sides 13a and tenth sides 13b are not marked. In the second direction Z, the more than two ninth sides 13a arranged consecutively are flush with each other, the more than two tenth sides 13b arranged consecutively are flush with each other, and the plurality of eighth sides 13c are flush with each other. In the first direction X, a minimum distance D5 from the ninth sides 13a to the first side surface 41 is greater than a maximum distance D6 from the tenth sides 13b to the first side surface 41, such that the distances from the ninth sides 13a to the first side surface 41 are all greater than the distances from the tenth sides 13b to the first side surface 41. In these embodiments, the distances between the ninth sides 13a and the first side surface 41 are equal and are all D5, and the distances between the tenth sides 13b and the first side surface 41 are equal and are all D6.

In some embodiments, in the second direction Z, the plurality of fourth sides 11c arranged consecutively form a fourth side group 11D, and the plurality fifth sides 12c arranged consecutively and the plurality of eighth sides 13c arranged consecutively can separately form side group structures similar to the fourth side group 11D. In the first direction X, in the fifth side 12c, eighth side 13c, and fourth side 11c adjacent to each other in the second direction Z, the eighth side 13c protrudes out of the fifth side 12c and the fourth side 11c, and the fifth side 12c protrudes out of the fourth side 11c.

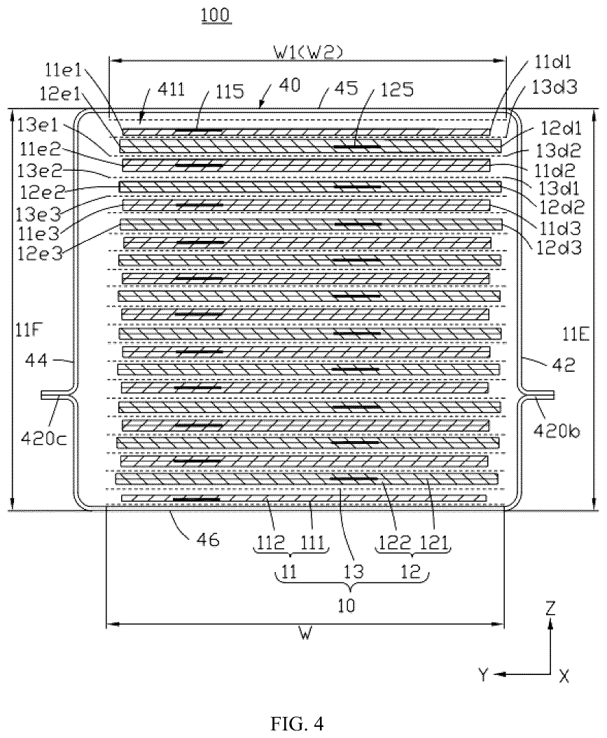

Referring to FIG. 4, the first conductive layer 11 further includes a plurality of eleventh sides 11d opposite the second side surface 42 and a plurality of twelfth sides 11e opposite the fourth side surface 44 in the third direction Y; the second conductive layer 12 further includes a plurality of thirteenth sides 12d opposite the second side surface 42 and a plurality of fourteenth sides 12e opposite the fourth side surface 44 in the third direction Y; and the first layer 13 further includes a plurality of fifteenth sides 13d opposite to the second side surface 42 and a plurality of sixteenth sides 13e opposite the fourth side surface 44 in the third direction Y. FIG. 4 shows three eleventh sides 11d1, 11d2 and 11d3, three twelfth sides 11e1, 11e2 and 11e3, three thirteenth sides 12d1, 12d2 and 12d3, three fourteenth sides 12e1, 12e2 and 12e3, three fifteenth sides 13d1, 13d2 and 13d3, and three sixteenth sides 13e1, 13e2 and 13e3; and the remaining eleventh sides 11d, twelfth sides 11e, thirteenth sides 12d, fourteenth sides 12e, fifteenth sides 13d, and sixteenth sides 13e are not marked. In the second direction Z, the plurality of eleventh sides 11d, the plurality of twelfth sides 11e, the plurality of thirteenth sides 12d, the plurality of fourteenth sides 12e, the plurality of fifteenth sides 13d, and the plurality of sixteenth sides 13e are separately flush with each other. In these embodiments, distances from the eleventh sides 11d, the thirteenth sides 12d, and the fifteenth sides 13d to the second side surface 42 are separately equal, and distances from the twelfth sides 11e, the fourteenth sides 12e, and the sixteenth sides 13e to the fourth side surface 44 are separately equal; and in the third direction Y, each of the thirteenth sides 12d protrudes out of the corresponding eleventh side 11d, each of the fifteenth sides 13d protrudes out of the corresponding thirteenth side 12d, each of the fourteenth sides 12e protrudes out of the twelfth side 11e, and each of the sixteenth sides 13e protrudes out of the twelfth side 11e. In the second direction Z, the plurality of eleventh sides 11d arranged consecutively form a fifth side group 11E; the plurality of thirteenth sides 12d arranged consecutively and the plurality of fifteenth sides 13d arranged consecutively can separately form side group structures similar to the fifth side group 11E; the plurality of twelfth sides 11e arranged consecutively form a sixth side group 11F; and the plurality of fourteenth sides 12e arranged consecutively and the plurality of sixteenth sides 13e arranged consecutively can separately form side group structures similar to the sixth side group 11F.

Referring to FIG. 1 to FIG. 4, the electrode assembly 10 has a length L in the first direction X and a length W in the third direction Y. The first layer 13 in the first side group 11A has a length L₁ in the first direction X, and the first layer 13 in the second side group 11B has a length L₂ in the first direction X, where L₁<L₂<L. The first layer 13 in the first side group 11A has a length W₁ in the third direction Y, and the first layer 13 in the second side group 11B has a length W₂ in the third direction Y, where W₁ and W₂ are equal to W.

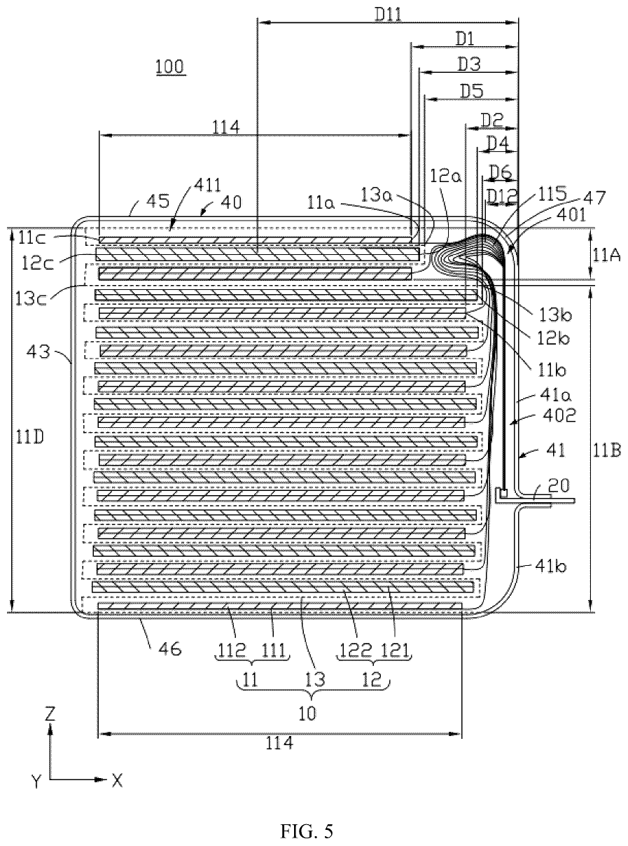

Referring to FIG. 5, in some embodiments, the electrode assembly 10 is formed by stacking a plurality of first conductive layers 11, a plurality of second conductive layers 12, and one first layer 13. Observed in the third direction Y, the first layer 13 is subjected to reciprocating Z-shaped bending in the second direction Z to form a plurality of layers. In the second direction Z, each first layer 13 separates adjacent two of the first conductive layers 11 and second conductive layers 12.

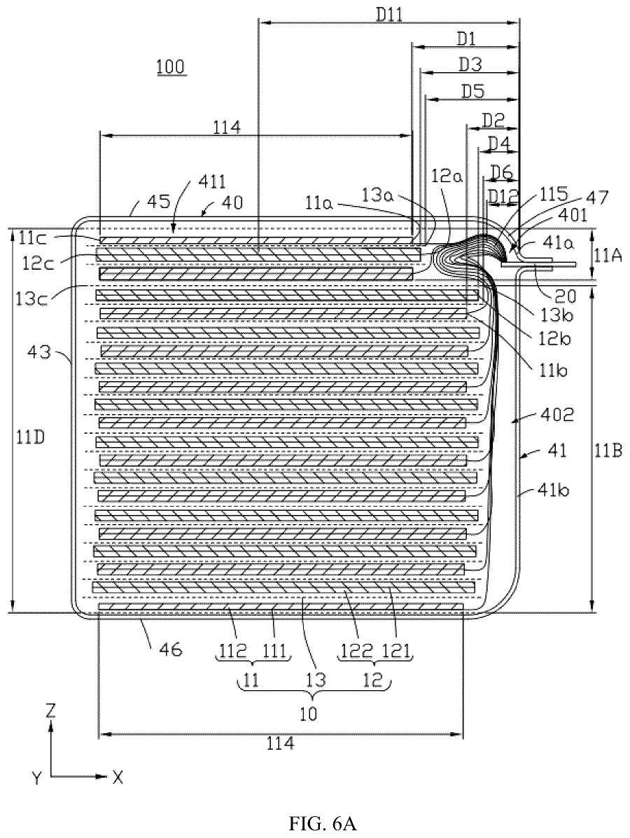

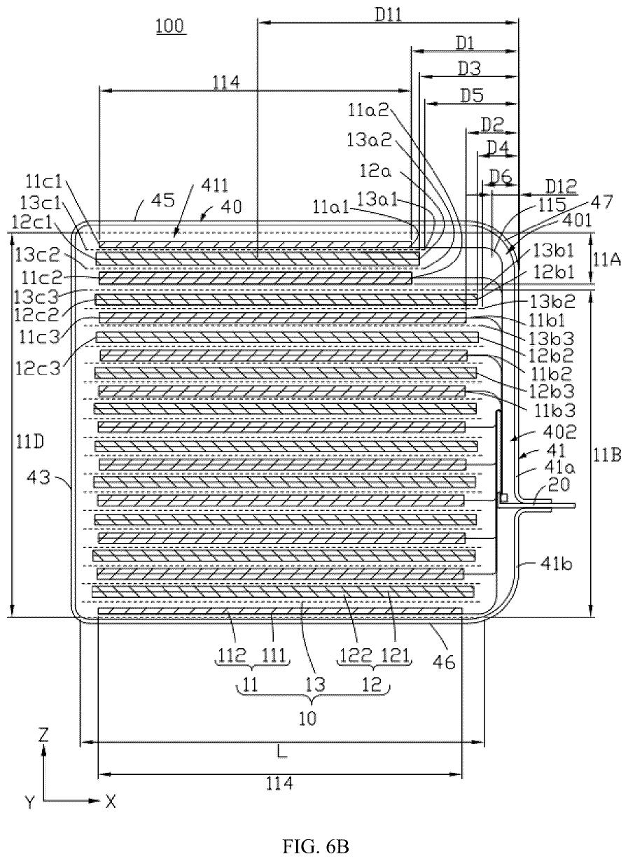

Referring to FIG. 6A, in some embodiments, the first conductive plate 20 is at least partially accommodated in the first cavity 401, and the first protrusion portion 115 is bent in the first cavity 401 and is connected to the first conductive plate 20 in the first cavity 401, thereby further reducing space occupied by the battery 100 in the first direction X and facilitating miniaturization of the battery 100.

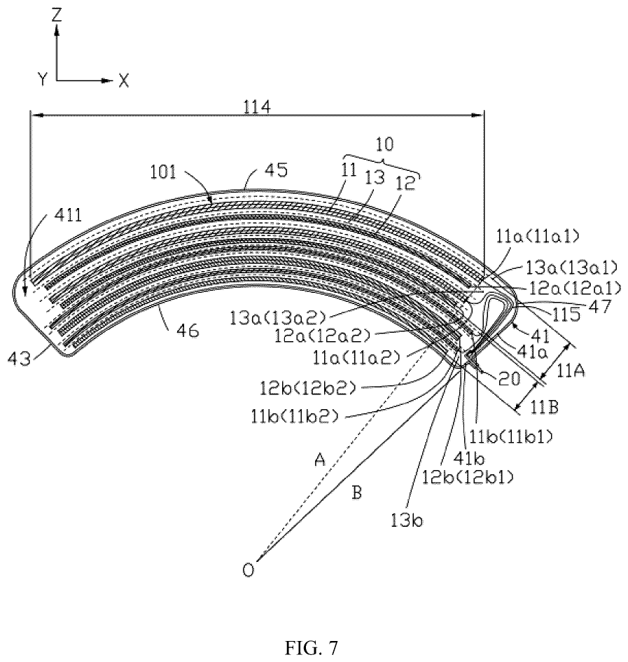

Referring to FIG. 6B, in some embodiments, the first protrusion portion 115 is bent in the second cavity 402, the first conductive plate 20 is at least partially accommodated in the second cavity 402 and is connected to the bent first protrusion portion 115. Referring to FIG. 7, in some embodiments, the electrode assembly 10 includes a bent portion 101 extending in the first direction X and protruding in the second direction Z. The first conductive layer 11, second conductive layer 12, and first layer 13 in the bent portion 101 are all bent toward a same side in the second direction Z. In these embodiments, in the second direction Z, the bent portion 101 is bent in a direction from the first side group 11A to the second side group 11B, such that the bent portion 101 has a portion protruding in a direction from the second side group 11B to the first side group 11A. Observed in the second direction Z, a straight line connecting adjacent two of the first sides 11a, a straight line connecting adjacent two of the sixth sides 12a, and a straight line connecting adjacent two of the ninth sides 13a in the first side group 11A are all intersected with a straight line coincident with the first side surface 41; and a straight line connecting adjacent two of the second sides 11b, a straight line connecting adjacent two of the seventh sides 12b, and a straight line connecting adjacent two of the tenth sides 13b in the second side group 11B are all intersected with the straight line coincident with the first side surface 41. In these embodiments, the first side surface 41 is a plane. FIG. 7 shows that a first straight line A connecting adjacent two of the first sides 11a in the first side group 11A and a second straight line B coincident with the first side surface 41 are intersected at a point O.

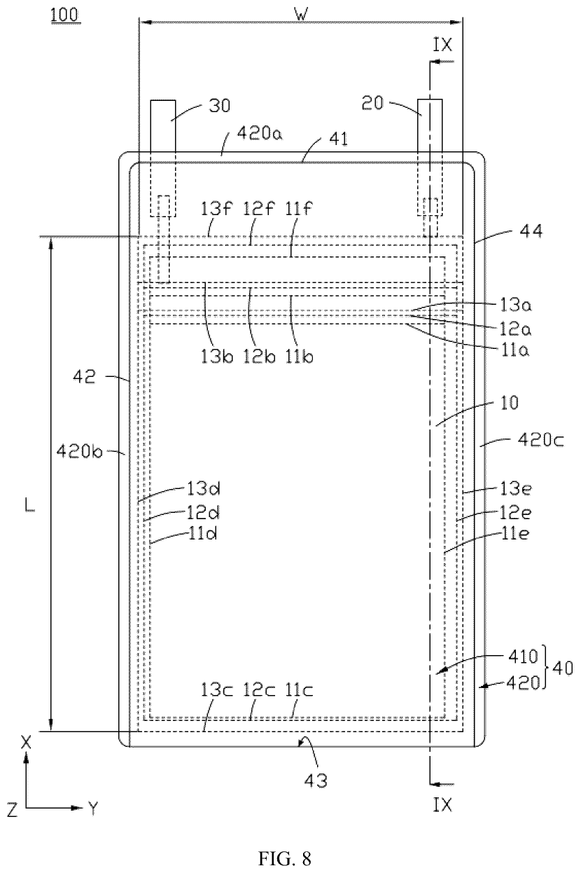

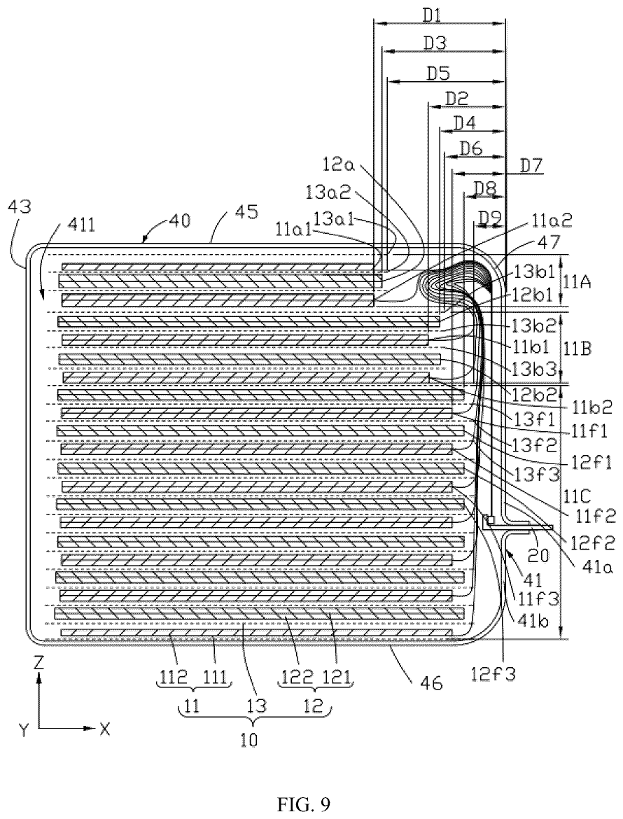

Referring to FIG. 8 and FIG. 9, in some embodiments, the plurality of sides of the first conductive layer 11 opposite the first side surface 41 in the first direction X further include more than two third sides 11f arranged consecutively in the second direction Z. For ease of understanding, FIG. 9 shows a 1st third side 11f1, a 2nd third side 11f2, and a 3rd third side 11f3 arranged consecutively in the second direction Z, and the remaining third sides 11f are not marked. In the second direction Z, the more than two third sides 11f arranged consecutively are flush with each other. In the first direction X, a maximum distance D7 from the third sides 11f to the first side surface 41 is less than a minimum distance D2 from the second sides 11b to the first side surface 41, such that the distances from the third sides 11f to the first side surface 41 are all less than the distances from the second sides 11b to the first side surface 41. In these embodiments, the distances from the second sides 11b to the first side surface 41 are equal and are all D2, and the distances from the third sides 11f to the first side surface 41 are equal and are all D7. In the second direction Z, the more than two third sides 11f arranged consecutively form a third side group 11C, and distances from the second sides 11b in the second side group 11B to the first side surface 41 are all greater than distances from the third sides 11f in the third side group 11C to the first side surface 41.

The plurality of sides of the second conductive layer 12 opposite the first side surface 41 in the first direction X further include more than two seventeenth sides 12f arranged consecutively in the second direction Z, and the plurality of sides of the first layer 13 opposite the first side surface 41 in the first direction X further include more than two eighteenth sides 13f arranged consecutively in the second direction Z. For ease of understanding, FIG. 9 shows three seventeenth sides 12f1, 12f2, and 12f3 as well as three eighteenth sides 13f1, 13f2, and 13f3, and the remaining seventeenth sides 12f and eighteenth sides 13f are not marked. In the second direction Z, the more than two seventeenth sides 12f arranged consecutively are flush with each other and can form a side group structure similar to the third side group 11C, and the more than two eighteenth sides 13f arranged consecutively are flush with each other and can form a side group structure similar to the third side group 11C. In these embodiments, distances from the seventh sides 12b to the first side surface 41 are equal and are all D4; distances from the tenth sides 13b to the first side surface 41 are equal and are all D6; distances from the seventeenth sides 12f to the first side surface 41 are equal and are all D8; and distances from the eighteenth sides 13f to the first side surface 41 are equal and are all D9.

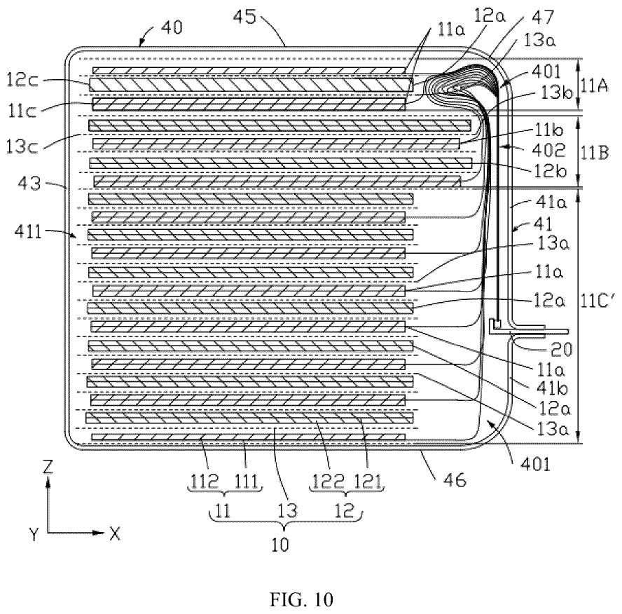

Referring to FIG. 10, in some embodiments, the more than two first sides 11a arranged consecutively in the second direction Z further form a third side group 11C′. In the second direction Z, the first side group 11A and the third side group 11C′ are located on two sides of the second side group 11B.

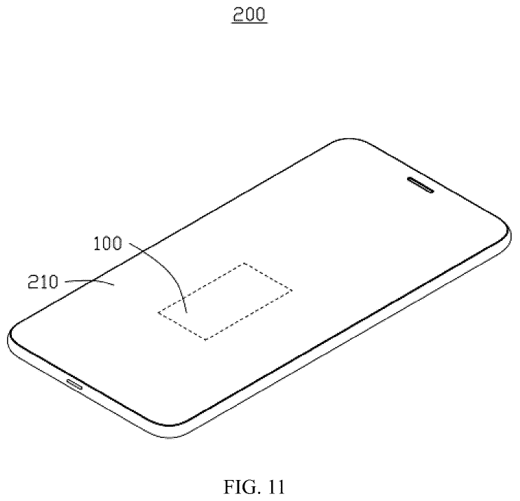

Referring to FIG. 11, an embodiment of this application further provides an electronic apparatus 200. The electronic apparatus 200 includes a body 220 and a battery 100. The battery 100 is accommodated in the body 220. The electronic apparatus 200 may be one of a mobile phone, a tablet computer, or an e-reader.

The electronic apparatus 200 being a mobile phone is used as an example in this application. The battery 100 is disposed in the mobile phone to provide power for the mobile phone, and the body 220 is a mobile phone structure. It can be understood that in other embodiments, the electronic apparatus 200 may alternatively be another structure, which is not limited to the foregoing mobile phone, tablet computer, or e-reader.

In the battery provided in this application, the electrode assembly is provided with the first side group and the second side group on a side connected to the conductive plate, forming a stair-stepping edge structure. In addition, a stable cavity structure is formed between the electrode assembly and the housing by the first side group, the second side group, and side surfaces of the housing. The cavity structure can be used for storing an electrolyte and gas so as to prolong the service life of the battery. Moreover, due to the presence of the cavity structure, a sufficient distance is present between the electrode assembly and the housing, thereby reducing the risk of powder falling and housing damage caused by extrusion of corners of the electrode assembly during dropping of the battery and prolonging the service life.

The following describes the performance of the battery provided in this application with reference to specific examples and comparative examples.

### EXAMPLE 1

The first conductive layer 11 and the second conductive layer 12 were placed on two sides of the first layer 13 to form the electrode assembly 10, the electrode assembly 10 was put into the housing 40, and followed by electrolyte injection, packaging, and formation to obtain a finished battery as shown in FIG. 4. In the first direction X, the first conductive layer 11 in the second side group 11B was 5 mm longer than the first layer 13 in the first side group 11A. In the first direction X, the second conductive layer 12 in the first side group 11A was 2.5 mm longer than the first conductive layer 11, and the first layer 13 was 2.5 mm longer than the second conductive layer 12. In the first direction X, the second conductive layer 12 in the second side group 11B was 2.5 mm longer than the first conductive layer 11, and the first layer 13 was 2.5 mm longer than the second conductive layer 12.

### EXAMPLE 2

The first conductive layer 11 and the second conductive layer 12 were placed on two sides of the first layer 13 to form the electrode assembly 10, the electrode assembly 10 was put into the housing 40, and followed by electrolyte injection, packaging, and formation to obtain a finished battery as shown in FIG. 10. In the first direction X, the first conductive layer 11 in the second side group 11B was 5 mm longer than the first layer 13 in the first side group 11A (the third side group 11C). In the first direction X, the second conductive layer 12 in the first side group 11A (the third side group 11C) was 2.5 mm longer than the first conductive layer 11, and the first layer 13 was 2.5 mm longer than the second conductive layer 12. In the first direction X, the second conductive layer 12 in the second side group 11B was 2.5 mm longer than the first conductive layer 11, and the first layer 13 was 2.5 mm longer than the second conductive layer 12.

### EXAMPLE 3

The first conductive layer 11 and the second conductive layer 12 were placed on two sides of the first layer 13 to form the electrode assembly 10, the electrode assembly 10 was put into the housing 40, and followed by electrolyte injection, packaging, and formation to obtain a finished battery as shown in FIG. 8. In the first direction X, the first conductive layer 11 in the second side group 11B was 1 mm longer than the first layer 13 in the first side group 11A. In the first direction X, the second conductive layer 12 in the first side group 11A was 0.4 mm longer than the first conductive layer 11, and the second conductive layer 12 in the second side group 11B is 0.4 mm longer than the first conductive layer 11.

### COMPARATIVE EXAMPLE 1

The first conductive layer and the second conductive layer were placed on two sides of the first layer to form the electrode assembly, the electrode assembly was put into the housing, and followed by electrolyte injection, packaging, and formation to obtain a finished battery. In the second direction Z, a plurality of edges of the first conductive layer opposite to the side surfaces of the housing were flush with each other; a plurality of edges of the second conductive layer opposite to the side surfaces of the housing were flush with each other; a plurality of edges of the first layer opposite to the side surfaces of the housing were flush with each other; the edges of the second conductive layer extended 1.5 mm beyond the edges of the first conductive layer; and the edges of the first layers extended 2.5 mm beyond the edges of the second conductive layer.

In each group of examples and comparative examples, five samples of batteries were taken for a cycling test and a drop test. Test results are shown in Table 1.

Cycling test: The battery samples were charged at 0.2 C at 25° C., then discharged to a cut-off voltage, and then constant-current and constant-voltage charged to a limited voltage at 0.8 C; observation was performed to check whether the appearances of the batteries were abnormal (for example, local thickness was increased); and then the batteries were subjected to 1000 cycles at a charging/discharging current of 0.8 C/1 C, to obtain a capacity retention rate and an electrode assembly swelling coefficient.

Drop test: Under room temperature, the battery samples were charged to a limited voltage at a current of 0.2 C, the battery samples were fixed in a drop test box and were made to drop from a height of 1.8 m onto a marble slab, where the battery samples dropped six times as one round in the following order: a first surface faced down, a second surface faced down, a top plane faced down, a left plane faced down, a bottom surface faced down, and a right plane faced down. After each round of drop, observation was performed to check whether the surface of the electrode assembly was damaged, and an open-loop voltage of the battery sample was measured; if the voltage was lower than 3 V, it was determined that the battery sample had not pass the drop test; and if the voltage was higher than 3 V, it was determined that the battery sample had passed the drop test.

TABLE 1

| | | Electrode | |
|---|---|---|---|
| | Capacity retention | assembly swelling | |
| | rate at 25° C. | rate at 25° C. | Drop test |
| | after 1000 cycles | after 1000 cycles | results |
| Example 1 | 83% | 7% | 5/5 |
| Example 2 | 85% | 5.5% | 5/5 |
| Example 3 | 85% | 5% | 5/5 |
| Comparative | 80% | 10% | 3/5 |
| example 1 | | | |

Note:
X/5 represents that X of the 5 tested samples have passed the drop test.

It can be learned from the test results in Table 1 that the comparison between examples 1 to 3 and comparative example 1 shows that the provision of the first side group and the second side group can prolong the service life of the battery.

The descriptions disclosed above are merely preferred embodiments of this application, and certainly cannot constitute any limitation on this application. Accordingly, equivalent changes made in accordance with this application still fall within the scope of this application.

What is claimed is:

1. A battery, comprising:
an electrode assembly, comprising a first conductive layer, a second conductive layer, and a first layer disposed between the first conductive layer and the second conductive layer, wherein the first layer contains an insulating material;
a first conductive plate, connected to the first conductive layer and extending in a first direction from the first conductive layer; and
a housing, encapsulating the electrode assembly and covering at least a part of the first conductive plate; wherein
the housing comprises a first side surface opposite to the electrode assembly in the first direction; the first conductive layer comprises a plurality of sides opposite to the first side surface in the first direction, wherein the plurality of sides comprise a first side group formed by more than two first sides arranged consecutively and a second side group formed by more than two second sides arranged consecutively in a second direction; the second direction is perpendicular to the first direction; and in the first direction, distances from the first sides in the first side group to the first side surface are all greater than distances from the second sides in the second side group to the first side surface.

2. The battery according to claim 1, wherein the electrode assembly further comprises a bent portion extending in the first direction and bent along the second direction.

3. The battery according to claim 2, wherein the electrode assembly comprises a portion protruding from the second side group to the first side group in the second direction.

4. The battery according to claim 2, wherein viewed in the second direction, the first side group and the first side surface are arranged in a manner as follows: a first straight line connecting adjacent two of the first sides in the first side group is intersected with a second straight line coincident with the first side surface.

5. The battery according to claim 1, wherein the electrode assembly is formed by stacking or winding the first conductive layer, the first layer, and the second conductive layer, and a direction of a winding axis of the electrode assembly is the first direction.

6. The battery according to claim 1, wherein viewed in the second direction, the first conductive layer comprises a first region and a first protrusion portion; a distance between the first side surface and the first region in the first direction is greater than a distance between the first side and the first side surface; and a distance between the first protrusion portion and the first side surface is less than the distance between the first side and the first side surface.

7. The battery according to claim 6, wherein the first protrusion portion is bent between the first region and the first side surface.

8. The battery according to claim 7, wherein a first cavity is formed between the first side group and the housing, and the first protrusion portion is bent in the first cavity.

9. The battery according to claim 1, wherein the first conductive layer is a positive electrode.

10. The battery according to claim 1, wherein the first conductive layer comprises a first conductor layer, and the first conductor layer comprises aluminum.

11. The battery according to claim 1, wherein the second conductive layer is a negative electrode.

12. The battery according to claim 1, wherein the second conductive layer comprises a second conductor layer, and the second conductor layer comprises copper.

13. The battery according to claim 8, wherein the first conductive layer is a positive electrode, and the second conductive layer is a negative electrode.

14. The battery according to claim 1, wherein a second cavity is formed between the second side group and the housing.

15. The battery according to claim 1, wherein the electrode assembly has a length L in the first direction, the first layer located in the first side group has a length L₁ in the first direction, and a second layer located in the second side group has a length L₂ in the first direction, wherein L₁<L₂<L.

16. An electronic apparatus, comprising the battery according to claim 1.

17. The electronic apparatus according to claim 16, wherein the electrode assembly further comprises a bent portion extending in the first direction and bent along the second direction.

18. The electronic apparatus according to claim 17, wherein the electrode assembly comprises a portion protruding from the second side group to the first side group in the second direction.

19. The electronic apparatus according to claim 17, wherein viewed in the second direction, the first side group and the first side surface are arranged in a manner as follows: a first straight line connecting adjacent two of the first sides in the first side group is intersected with a second straight line coincident with the first side surface.

20. The electronic apparatus according to claim 16, wherein the electrode assembly is formed by stacking or winding the first conductive layer, the first layer, and the second conductive layer, and a direction of a winding axis of the electrode assembly is the first direction.
